(19) United States
(12) Patent Application Publication
(10) Pub. No.: US 2020/0074442 A1
(43) Pub. Date: Mar. 5, 2020

(54) TRANSACTION AUTHORIZATION BASED ON TRANSACTION, TIME, AND GEOLOCATION DEPENDENT OPTICAL MACHINE-READABLE CODES

(71) Applicant: CA, Inc., New York, NY (US)

(72) Inventors: Vijay Shashikant Kulkarni, Bangalore (IN); Lyju Vadassery, Mumbai (IN); Vikrant Nandakumar, Bangalore (IN); Harmeet Singh Gujral, Bengaluru (IN)

(73) Assignee: CA, Inc., New York, NY (US)

(21) Appl. No.: 16/117,686

(22) Filed: Aug. 30, 2018

(51) Int. Cl. G06Q 20/32; G06Q 20/40

(52) U.S. Cl. CPC G06Q 20/3276; G06Q 20/3227; G06Q 20/4016; G06Q 20/4097

(57) ABSTRACT

A transaction authorization server receives an optical machine-readable code (OMRC) request message from a merchant terminal, which includes a transaction reference number, a transaction time, a transaction amount, and a merchant identifier associated with the merchant terminal. OMRC information is generated based on a combination of the transaction reference number and the transaction time. An OMRC response message is generated containing the OMRC information and sent toward the merchant terminal. The OMRC information is stored in a data structure with an association to the merchant identifier. An OMRC verification message is received from a user terminal, and is selectively validated based on the OMRC information that was stored. When validated, the server sends to the user terminal an OMRC validation message containing an indication that the decoded OMRC information is valid, the transaction amount, and the merchant identifier.

### FIELD

The present invention relates generally to electrical computers and digital processing systems, and more particularly, to interprogram communications with a remote server computer for authorizing transactions performed between client terminals.

### BACKGROUND

Transactions are increasingly being performed without use of credit cards, so called “cardless transactions.” The process of performing a cardless transaction can include a purchaser operating a user terminal to use a camera to scan a quick response (QR) code sticker that a merchant has displayed near the merchant's point of sale (POS) terminal. The QR code is supposed to uniquely identify the merchant. The user terminal reports the QR code to an authorization server. The POS terminal reports the transaction amount and a transaction number to the authorization server. The authorization server validates the transaction and initiates transfer of funds from a bank or credit account held by the purchaser's banking institution to a merchant's account that is identified based on the QR code.

A security weakness in this process is reliance on the QR code to identify the merchant's account. A fraudster can print a sticker having a QR code that identifies the fraudster's account and attach the sticker to cover the merchant's QR code. Purchasers then unknowingly scan the fraudster's QR code which causes funds to be transferred from the purchasers' accounts to the fraudster's account instead of to the merchant's account. Moreover, the merchant may observe via the purchasers' terminals displayed notifications that payments have been authorized but be unaware that the payments have been fraudulently misdirected to the fraudster's account.

### SUMMARY

Some embodiments described herein are directed to a transaction authorization server that includes a network interface, a processor coupled to the network interface, and a memory coupled to the processor. The memory includes a non-transitory computer-readable storage medium storing computer-readable program code therein. When executed, the computer-readable program code causes the following operations to be performed by the processor of the transaction authorization server. An optical machine-readable code (OMRC) request message is received from a merchant terminal, which includes a transaction reference number, a transaction time, a transaction amount, and a merchant identifier associated with the merchant terminal. OMRC information is generated based on a combination of the transaction reference number and the transaction time. An OMRC response message is generated that contains the OMRC information. The OMRC response message is sent toward the merchant terminal. The OMRC information is stored in a data structure with an association to the merchant identifier.

Accordingly, the transaction authorization server generates OMRC information, which may correspond to QR code information, that is sent to the merchant terminal responsive to receiving a request therefrom. The merchant terminal can display the OMRC for scanning by a user terminal. The user terminal communicates information from the OMRC to the transaction authorization server for selective validation and communication of a result thereof back to the user terminal and/or to the merchant terminal.

Some related embodiments described herein are directed to a merchant terminal that includes a network interface configured to communicate through data networks with a transaction authorization server, a display device, a processor coupled to the network interface and the display device, and a memory coupled to the processor. The memory includes a non-transitory computer-readable storage medium storing computer-readable program code therein. When executed, the computer-readable program code causes the following operations to be performed by the processor of the merchant terminal. A transaction reference number is generated for a transaction with a user. A transaction time is obtained based on a time of day of the transaction. A transaction amount is obtained, a merchant identifier which is associated with merchant terminal is obtained. An OMRC request message is sent to the transaction authorization server, which includes the transaction reference number, the transaction time, the transaction amount, and the merchant identifier. An OMRC response message containing OMRC information is received from the transaction authorization server. An OMRC is displayed on the display device based on the OMRC information.

Accordingly, the merchant terminal receives OMRC information from the transaction authorization server, responsive to sending the transaction reference number, the transaction time, the transaction amount, and the merchant identifier there to. The merchant terminal then displays an OMRC, which may correspond to QR code information, based on the OMRC information.

Some related embodiments described herein are directed to a user terminal that includes a wireless transceiver configured to communicate through a wireless air interface with a radio access network, an OMRC scanner device, a display device, a processor coupled to the wireless transceiver, the OMRC scanner device, and the display device, and a memory coupled to the processor. The memory includes a non-transitory computer-readable storage medium storing computer-readable program code therein. The OMRC scanner device is operated to scan an OMRC displayed by a merchant terminal. The OMRC is decoded to obtain decoded OMRC information. An OMRC verification message containing the decoded OMRC information and a user terminal identifier is transmitted to a transaction authorization server. An OMRC validation message is received. When the OMRC validation message that is received contains an indication that the decoded OMRC information is valid and further contains a transaction amount and a merchant identifier, further operations are performed to: display, on the display device, the transaction amount, the merchant identifier, and a query for a user to authorize the transaction; and responsive to receiving through a user input interface a user response authorizing the transaction, transmit a transaction authorization message toward the transaction authorization server containing an indication that the transaction is authorized.

Other apparatuses, methods, and computer program products according to embodiments will be or become apparent to one with skill in the art upon review of the following drawings and detailed description. It is intended that all such additional apparatuses, methods, and computer program products, including any and all combinations of operations performed thereby, be included within this description and protected by the accompanying claims.

### BRIEF DESCRIPTION OF THE DRAWINGS

Aspects of the present disclosure are illustrated by way of example and are not limited by the accompanying drawings. In the drawings:

FIG. 1 is a block diagram illustrating components of a computer system that includes a user terminal, a merchant terminal, and a transaction authorization server that are configured to operate in accordance with some embodiments;

FIGS. 2 and 3 are combined data flow diagrams and flowcharts of operations that are performed by the user terminal, the merchant terminal, and the transaction authorization server of FIG. 1 in accordance with some embodiments;

FIG. 4 is a block diagram of components of the user terminal of FIG. 1 in accordance with some embodiments;

FIG. 5 is a block diagram of components of the merchant terminal of FIG. 1 in accordance with some embodiments; and

FIG. 6 is a block diagram of components of the transaction authorization server of FIG. 1 in accordance with some embodiments.

### DETAILED DESCRIPTION

Various embodiments will be described more fully hereinafter with reference to the accompanying drawings. Other embodiments may take many different forms and should not be construed as limited to the embodiments set forth herein. Like numbers refer to like elements throughout.

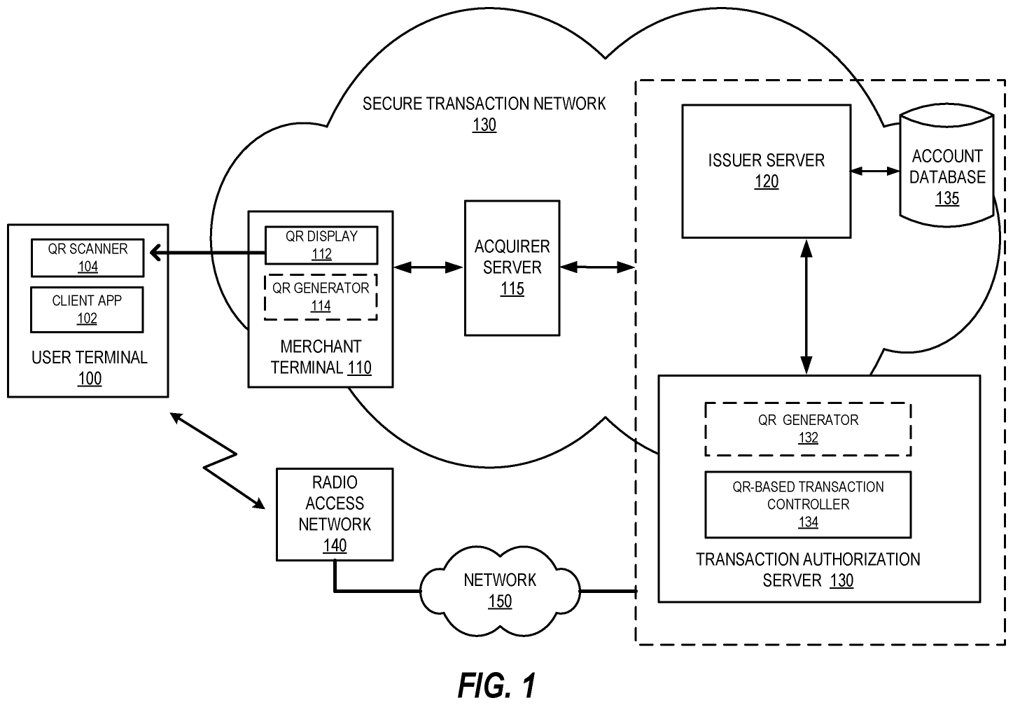

Various embodiments disclosed herein are directed to providing increased security during transactions between users and merchants, which may avoid the fraudulent transfer of transaction funds that can arise with known systems described above. Example operations that can performed for these embodiments will be described in example environment of a computer system shown in FIG. 1. FIG. 1 is a block diagram illustrating components of a computer system that includes a user terminal 100, a merchant terminal 110, and a transaction authorization server 130 that are configured to operate in accordance with some embodiments.

Referring to FIG. 1, the merchant terminal 110 is connected to an acquirer server 115, which communicates with an issuer server 120 and/or with the transaction authorization server 130, some or all of which are communicatively coupled to payment nodes that define a secure transaction network 130 having network nodes that route communications between these components. The secure transaction network 130 can include a private network and/or may include components of a public network, e.g., Internet, with secure encryption providing secure communication pipelines therethrough. Network nodes of the secure payments network 142 may be interconnected by a secure wide area network (WAN), local area network (LAN), Intranet, and/or other private network, which may not be accessible by the nodes of the network 142.

In some embodiments, the transaction authorization server 130 may be a third-party server that is communicatively coupled to the issuer server 120 and is configured to perform various functions on behalf of the issuer server 120. The issuer server 120 and transaction authorization server 130 may be implemented as a single server, separate servers, or a network of servers (physical and/or virtual), which may be co-located in a server farm or located in different geographic regions. The issuer server 120 is connected to an account database 135 containing user account information, e.g., credit card account information for cardholders and may operate to retrievably store credit card account balances and contact information for credit card holders responsive to messages from the issuer server 120.

At least one of the issuer server 120 and the transaction authorization server 130 is communicatively coupled, via one or more network nodes that are outside of the secure payments network 142, to a user terminal 100 that is operated by a user (e.g., credit card account holder, debit account holder, etc.) associated with an account managed by the issuer server 120 (e.g., credit card account, debit account, etc.). The user terminal 100 may be any wireless mobile consumer electronic device that is configured to transmit and receive data or communications to and from the servers 120 and/or 130 via a radio access network 140. It will be appreciated that, in various embodiments described herein, the user terminal 100 may be a mobile phone (e.g., smart phone, cellular phone, etc.), tablet, portable media player, laptop computer, desktop computer, personal digital assistant (PDA), and/or wearable computing device (e.g., watch), or other consumer electronic device. The radio access network 140 can include, but is not limited to, cellular radio access transceiver base stations (e.g., 3GPP 3G, 3G, 4G, NR cellular protocols) and/or Wi-Fi radio access points.

As described herein, a computer server (“server” for brevity) may include a computer or cluster of computers. For example, the computer server can be a large mainframe, a minicomputer cluster, or a group of servers functioning as a unit. In one example, the computer server may be coupled to a Web server. The computer server may be coupled to a database and may include hardware (including one or more processors, memory, etc.), software, or combinations thereof for servicing the requests from one or more client computers. The computer server may include one or more computational apparatuses and may use any of a variety of computing structures, arrangements, and compilations for servicing the requests from one or more client computers.

An issuer may refer to a business entity (e.g., a bank) that maintains an account (e.g., a monetary account, such as a bank account, credit payment account, etc.) for a user (also referred to herein as an account holder). The account may be associated with a user terminal. A user terminal 100 can include a mobile payments application (client application) 102 installed thereon that is operated by a user to perform transactions (e.g., debit, credit, or other portable card) with a merchant terminal 110. An issuer is associated with an issuer server 120 that performs some or all of the functions of the issuer. For example, an issuer may store and/or define account parameters via the issuer server 120 associated with the account for use by the user terminal 100 and the account holder.

A merchant may refer to an entity that engages in electronic transactions for goods or services. A merchant terminal 110 may refer to a computer include a point-of-sale (POS) terminal, a point-of-banking (POB) terminal, an automated teller machine (ATM) terminal, and/or other terminal that is associated with the merchant and is operable to conduct a monetary transaction with a user/consumer account.

An acquirer may refer to a business entity (e.g., a commercial bank) that has a business relationship with a merchant or other entity. An acquirer may be associated with an acquirer server 115 that performs some or all of the functions of the acquirer. In some embodiments, an acquirer may include one or more entities that can perform some issuer and acquirer functions.

In one illustrative embodiment, a user (e.g., buyer) can make a payment at a merchant point-of-sale (POS) terminal 110 using a payment application 102 executed by the buyer's terminal 100. The merchant's POS terminal 110 displays on a display device 112 an optical machine-readable code (OMRC), such as a quick reference (QR) code, that is synchronized with the transaction authorization server 130. The OMRC is generated by the transaction authorization server 130 or by the merchant POS terminal 110 based on a combination of the transaction reference number for the transaction and a transaction time (e.g., present time of day of the transaction). The OMRC may be further generated based on a geographic location of the merchant terminal 110. An optical code scanner 104 (e.g., camera with QR scanning software) of the user terminal 100 is operated to scan the OMRC using the payment application 102. The scanned OMRC is decoded to obtain OMRC information which is sent to the transaction authorization server 130 for validation. When validated, the transaction authorization server 130 sends to the user terminal 100 a message containing an indication that the decoded OMRC information is valid, the transaction amount, and the merchant identifier. The user terminal 100 responsively displays the transaction authorization query prompting the user to authorize the transaction. When the user authorizes transaction, the user terminal 100 sends an authorization message to the transaction authorization server 130 which initiates transfer of funds from an issuer server associated with a user's account to an acquirer server associated with a merchant's account.

Because the OMRC is generated for each transaction and varies with the transaction number and the time of day, and which may vary based on the geographic location of the merchant, the fraudster cannot print a static OMRC in an attempt to cause funds to be transferred from the purchasers' accounts to the fraudsters account instead of to the merchant's account. Moreover, in view of the cooperative exchange of information between the merchant terminal 110 and the transaction authorization server 130, and the separate the cooperative exchange of information between the user terminal 100 and the transaction authorization server 130, both the user handling the user terminal 100 and the merchant handling the merchant terminal 110 can be assured that the transaction authorization server 130 is securely validating the transaction to ensure that funds are transferred under proper authorization by the user from the user's account to the correct merchant's account.

As used herein, an OMRC can be any optical code that can be scanned by a user terminal, and can include, but is not limited to, a QR code or other matrix barcode, two-dimensional optical code, or other multidimensional optical code. The OMRC may alternatively be a one-dimensional code, such as a barcode. For ease of explanation and understanding, the detailed description and figures refers to the use of QR codes and information. However, it is to be understood that embodiments herein are not limited to QR codes and maybe more generally used with any type of OMRC. Accordingly, each reference to a QR code herein may be replaced with OMRC.

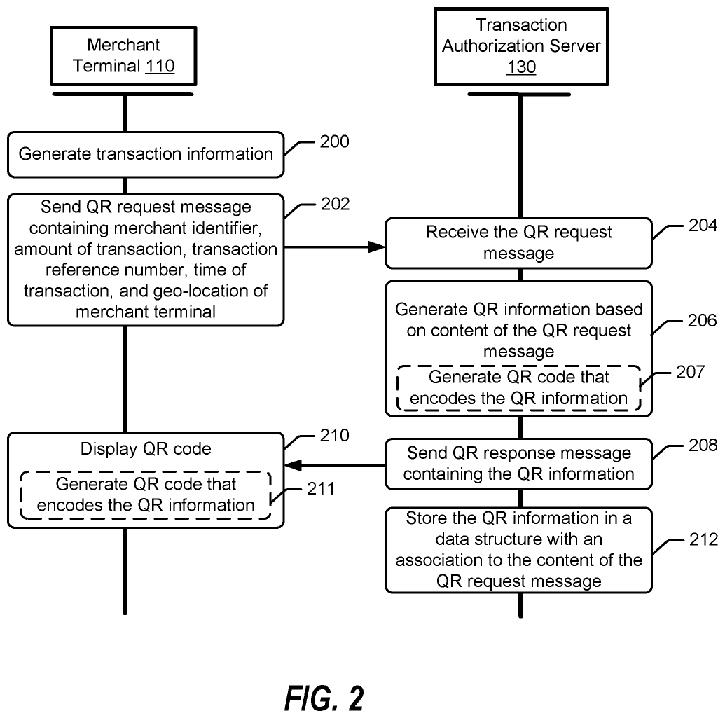

FIGS. 2 and 3 are combined data flow diagrams and flowcharts of operations that are performed by the user terminal 100, the merchant terminal 110, and the transaction authorization server 115 of FIG. 1 in accordance with some embodiments.

Referring to FIGS. 1 and 3, the merchant terminal 110 generates 200 transaction information for a transaction with a user. Generation of the transaction information can include generating a transaction reference number for a transaction with a user, obtaining a transaction time based on a time of day of the transaction, obtaining a transaction amount, and obtaining a merchant identifier associated with the merchant terminal 110. As will be explained in further detail below, generation of the transaction information may further include obtaining a geolocation of the merchant terminal 110. The merchant terminal 110 sends 202 to the transaction authorization server 130 an QR request message that includes the transaction reference number, the transaction time, the transaction amount, and the merchant identifier.

The transaction authorization server 130 receives 204 the QR request message containing the transaction reference number, the transaction time, the transaction amount, and the merchant identifier associated with the merchant terminal 110. The server 130 generates 206 QR information based on a combination of the transaction reference number and the transaction time.

The operation for generating 206 the information based on a combination of the transaction reference number and the transaction time, can include generating a QR code (or other OMRC) that encodes the QR (or other OMRC) information. The operation for generating 208 a QR response message containing the QR information and routing information for the merchant terminal, can include embedding the QR code into the QR response message.

The QR request message that is received 204 may further include a geographical location of the merchant terminal 110. The QR information can be generated 206 based on a combination of the geographical location of the merchant terminal 110, the transaction reference number, and the transaction time. The QR information may be generated 206 based on a combination of the merchant identifier, the geographical location of the merchant terminal, the transaction reference number, and the transaction time.

Responsive to receipt 204 of the QR request message, the server 130 can query an account database 135 and/or another database connected to the acquirer server 115 using the merchant identifier to determine a geographical location of the merchant terminal 110. The QR information can then be generated 206 based on a combination of the geographical location of the merchant terminal, the transaction reference number, and the transaction time.

The server 130 generates 206 a QR response message containing the QR information, and sends 208 the QR response message toward the merchant terminal 110 through the secure transaction network 142. The server 130 stores 212 the QR information in a data structure with an association to the merchant identifier.

The merchant terminal 110 receives the QR response message containing the QR information. The merchant terminal 110 displays 210 on the display device a QR code based on the QR information. The QR code displayed by the merchant terminal 110 can be scanned by the user terminal 100 which is operated by the user who is purchasing goods, services, performing an ATM transaction, etc. These operations by the transaction authorization server 130 may be performed by a QR-based transaction controller 134 which may include program code that is executed by one or more processors of the server 130.

The QR code may be generated by the transaction authorization server 130 or by the merchant terminal 110, for display by the merchant terminal 110. For example, in one embodiment the transaction authorization server 130 includes an QR generator 132 that generates the QR code based on a combination of the transaction reference number and the transaction time, and may further generate the QR code based on the geographic location of the merchant terminal 110 and/or the geographic location of the user terminal 100. Alternatively, the transaction authorization server 130 may communicate information to the merchant terminal 110 that is used by a QR generator 114 to generate the QR code for display by the QR code display 112. Accordingly, the operation to send 208 a QR response message containing “QR information” refers to the QR response message containing the QR code which can be generated 207 by a QR code generator 132 of the server 130 for display 210 by the merchant terminal 110, or can refer to the QR response message containing information that is to be used by the merchant terminal to generate the QR code for display (using the QR generator 114).

The merchant terminal 110 may obtain its geographic location. The QR request message that is sent by the merchant terminal 110 to the transaction authorization server 130 can include the geographical location of the merchant terminal 110, the transaction reference number, the transaction time, the transaction amount, and the merchant identifier. The transaction authorization server 130 can generate 207 the QR code to encode the geographical location of the merchant terminal, the transaction reference number, and the transaction time. The QR code may be generated to further encode the transaction amount and/or the merchant identifier

Thus, the QR response message generated by the server 130 can be used by a QR code generator 114 of the merchant terminal 110 to generate 211 the QR code to encode the transaction amount, the transaction reference number, and the transaction time for display 210 by the merchant terminal 110. When generating the QR code, the merchant terminal 110 may obtain its geographical location (e.g., by use of a satellite positioning circuit, performing network address translation to determine a geographic region corresponding to its routing network address, querying a database, etc.). The QR code can then be generated 211 or 207 to encode the geographical location, the transaction reference number, and the transaction time.

Although the communications are illustrated in FIG. 2 as being performed directly between the merchant terminal 110 in the transaction authorization server 130, intervening system nodes would typically be present, such as including the nodes shown in FIG. 1. For example, the QR request message can be received from the acquirer server 115 responsive to a message from the merchant terminal 110, and the QR response message can be sent to the acquirer server 115 for communication of content thereof to the merchant terminal 110.

Now referring to FIGS. 1 and 3, the user terminal 100 operates the QR code scanner device 104 to scan the QR code displayed 210 by the merchant terminal 110. The user terminal 100 decodes 302 the QR code to obtain decoded QR information. The user terminal 100 transmits 304 to the transaction authorization server 130 a QR verification message containing the decoded QR code information and a user terminal identifier.

The operation to transmit 304 the QR verification message can include obtaining a geographic location of the user terminal 100, and embedding the location of the user terminal 100, the decoded QR information, and the user terminal identifier in the QR verification message for transmission.

The transaction authorization server 130 receives 306 the QR verification message containing the decoded QR information. The server 130 attempts to match 308 the decoded QR information to the QR information that is stored 212 in the data structure with the association to the merchant identifier. The server 130 selectively validates 310 the decoded QR information based on whether a match is identified.

The QR verification message can contain the decoded QR information and a geographical location of the mobile terminal, and the transaction authorization server 130 can selectively validate the decoded QR information based on whether a match is identified and whether the location of the mobile terminal corresponds to a geographical location of the merchant terminal.

The server 130 sends 312 a QR validation message to the user terminal 100. Responsive to when the decoded QR information is validated, the QR validation message is configured to contain an indication that the decoded QR information is valid, the transaction amount, and the merchant identifier. In sharp contrast, when the decoded QR information is not valid, the server 130 responsively sends to the user terminal 100 a QR validation message that is configured to contain an indication that the decoded QR information is not valid which does not contain either of the transaction amount and the merchant identifier. When the decoded QR information is not valid, the server 130 may responsively send 314 a notification to the merchant terminal 110 indicating that the QR code is not valid.

The user terminal 100 processes 320 the QR validation message sent by the transaction authorization server 130. When the user terminal 100 determines that the QR validation message contains an indication that the decoded QR information is valid and further contains a transaction amount and a merchant identifier. User terminal 100 performs operations to display 326, on a display device, the transaction amount, the merchant identifier, and a query for a user to authorize the transaction. Responsive to the user terminal 100 receiving through a user input interface a user response authorizing the transaction, user terminal 100 transmits 328 a transaction authorization message toward the transaction authorization server 130 containing an indication that the transaction is authorized.

In sharp contrast, when the user terminal 100 processes 320 the QR validation message and determines contains an indication that the decoded QR information is invalid, the user terminal 100 can display 322 on the display device a notification indicating that the QR code displayed by the merchant terminal 110 is invalid and responsively deny the transaction by preventing communication of the message to the transaction authorization server 130 that would initiate transfer of funds.

With further reference to FIG. 1, the QR request message can be received by the transaction authorization server 130 from the merchant terminal 110 through the secure authorization network 142 including a plurality of network nodes. Similarly, the QR response message can be sent by the transaction authorization server 130 to the merchant terminal 110 through the secure authorization network 142. In sharp contrast, the QR verification message is received transaction authorization server 130 from the user terminal 100 through a radio access network node 140 that is outside of the plurality of network nodes of the secure authorization network 142. Similarly, the QR validation message is sent by the transaction authorization server 130 to the user terminal 100 through the radio access network node 140 that is outside of the plurality of network nodes of the secure authorization network 142. In this manner, validation of the transaction between the user terminal 100 and the merchant terminal 110 is increased by using two different communication pathways: the secure transaction network 142 between the merchant terminal 110 in the transaction authorization server 130; and the radio access network and data network 150 (e.g., cellular backbone network) between the user terminal 100 and the transaction authorization server 130. Using two different networks in this manner further complicates the ability for a fraudster to attempt to fraudulently spoof communications is appearing to come from the user terminal 100 or the merchant terminal 110 and attempt to trick the transaction authorization server 130 into facilitating transfer of funds from the merchant's account to the fraudsters account.

Example User Terminal, Merchant Terminal, and Transaction Authorization Server

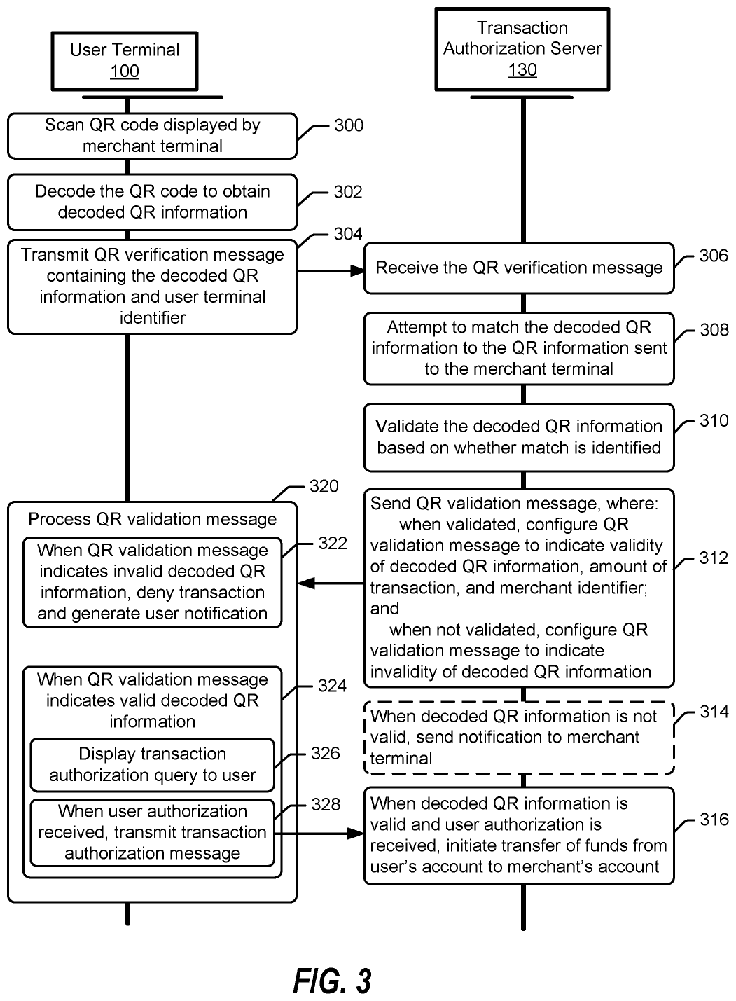

FIG. 4 is a block diagram of components of the user terminal of FIG. 1 in accordance with some embodiments. Referring to FIG. 4, the user terminal 100 includes a processor 400, a memory for 10, a wireless transceiver 420, and an OMRC (e.g., QR code) scanner 104 (e.g., camera and OMRC decoder software). The wireless transceiver 420 can include, but is not limited to, a LTE or other cellular transceiver, WLAN transceiver (IEEE 802.11), or other radio communication transceiver configured to communicate with the radio access network 140.

The processor 400 may include one or more data processing circuits, such as a general purpose and/or special purpose processor (e.g., microprocessor and/or digital signal processor) that may be collocated or distributed across one or more networks. The processor 400 is configured to execute computer program code, e.g. client application 102, in the memory 410, described below as a non-transitory computer readable medium, to perform at least some of the operations described herein as being performed by an access control computer. The computer program code when executed by the processor 400 causes the processor 400 to perform operations in accordance with one or more embodiments disclosed herein for the user terminal 100. The user terminal 100 may further include a user input interface 430 (e.g., touch screen, keyboard, keypad, etc.) and a display device 440.

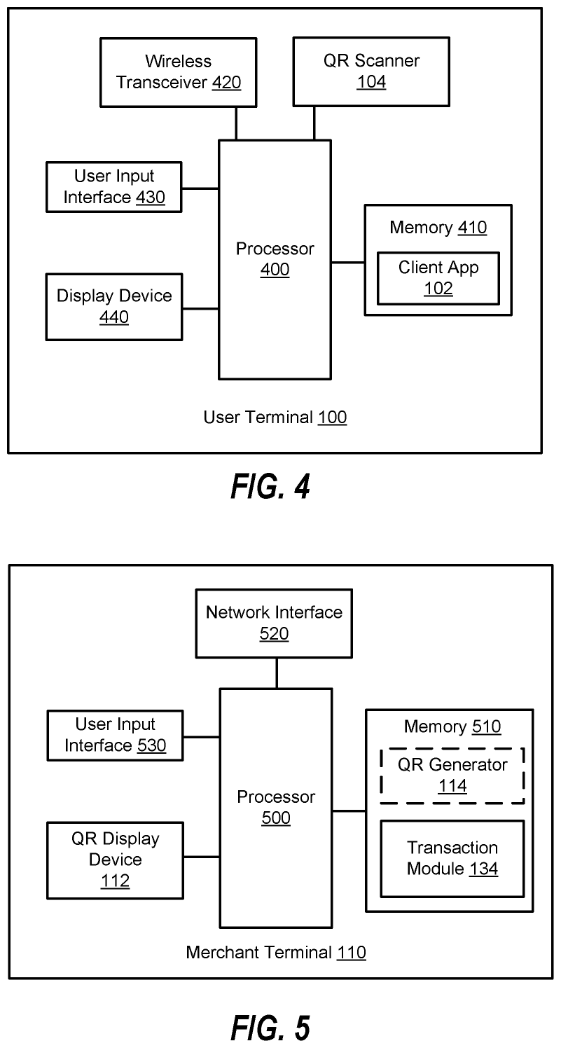

FIG. 5 is a block diagram of components of the merchant terminal 110 of FIG. 1 in accordance with some embodiments. Merchant terminal 110 includes a processor 500, a memory 510, and a network interface 520 which may include a radio access network transceiver and/or a wired network interface (e.g., Ethernet interface). The network interface 520 is configured to communicate with the transaction authorization server 130 through the secure transaction network 142.

The processor 500 may include one or more data processing circuits, such as a general purpose and/or special purpose processor (e.g., microprocessor and/or digital signal processor) that may be collocated or distributed across one or more networks. The processor 500 is configured to execute computer program code, e.g., the transaction processing module 134 and the QR generator 114, in the memory 610, described below as a non-transitory computer readable medium, to perform at least some of the operations described herein as being performed by a merchant terminal. The computer program code when executed by the processor 500 causes the processor 500 to perform operations in accordance with one or more embodiments disclosed herein for the merchant terminal 110. The merchant terminal 110 may further include a user input interface 530 (e.g., touch screen, keyboard, keypad, etc.) and display device 112 for displaying the QR code or other OMRC.

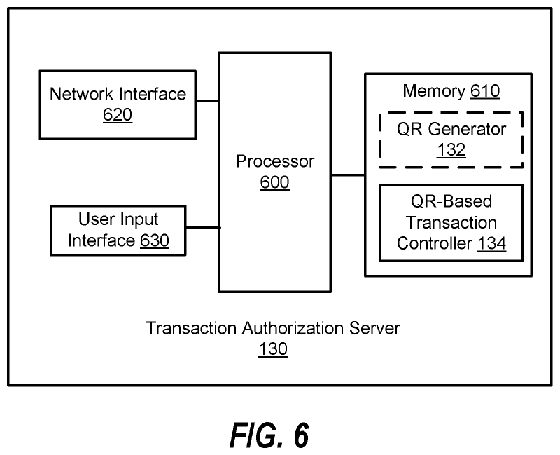

FIG. 6 is a block diagram of components of the transaction authorization server 130 of FIG. 1 in accordance with some embodiments. The transaction authorization server 130 includes a processor 600, a memory 610, and a network interface 620 which can include, but is not limited to, a wired network interface (e.g., Ethernet) or wireless interface configured to communicate with the merchant terminal 110 via the secure transaction network 142 and configured to communicate with the user terminal 100 via the radio access network 140 and the data network 150.

processor 600 may include one or more data processing circuits, such as a general purpose and/or special purpose processor (e.g., microprocessor and/or digital signal processor) that may be collocated or distributed across one or more networks. The processor 600 is configured to execute computer program code, e.g., the QR-based transaction controller 134 in the QR generator 132, in the memory 610, described below as a non-transitory computer readable medium, to perform at least some of the operations described herein as being performed by an access control computer. The computer program code when executed by the processor 600 causes the processor 600 to perform operations in accordance with one or more embodiments disclosed herein for the transaction authorization server 130. The transaction authorization server 130 may further include a user input interface 630 (e.g., touch screen, keyboard, keypad, etc.) and a display device.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A transaction authorization server comprising:
a network interface configured to communicate through data networks with user terminals and merchant terminals;
a processor coupled to the network interface; and
a memory coupled to the processor, the memory comprising a non-transitory computer-readable storage medium storing computer-readable program code therein that, when executed by the processor, causes the processor to perform operations comprising:
receiving from a merchant terminal an optical machine-readable code (OMRC) request message comprising a transaction reference number, a transaction time, a transaction amount, and a merchant identifier associated with the merchant terminal;
generating OMRC information based on a combination of the transaction reference number and the transaction time;
generating an OMRC response message containing the OMRC information;
sending the OMRC response message toward the merchant terminal; and
storing the OMRC information in a data structure with an association to the merchant identifier.

2. The transaction authorization server of claim 1, wherein:
the operation for generating OMRC information based on a combination of the transaction reference number and the transaction time, comprises generating a quick response (QR) code that encodes the OMRC information; and
the operation for generating an OMRC response message containing the OMRC information and routing information for the merchant terminal, comprises embedding the QR code into the OMRC response message.

3. The transaction authorization server of claim 1, wherein:
the OMRC request message that is received further comprises a geographical location of the merchant terminal; and
the OMRC information is generated based on a combination of the geographical location of the merchant terminal, the transaction reference number, and the transaction time.

4. The transaction authorization server of claim 3, wherein:
the OMRC information is generated based on a combination of the merchant identifier, the geographical location of the merchant terminal, the transaction reference number, and the transaction time.

5. The transaction authorization server of claim 1, further comprising:
responsive to receipt of the OMRC request message, querying an account database using the merchant identifier to determine a geographical location of the merchant terminal; and
the OMRC information is generated based on a combination of the geographical location of the merchant terminal, the transaction reference number, and the transaction time.

6. The transaction authorization server of claim 1, wherein the operations further comprise:
receiving from a user terminal an OMRC verification message containing decoded OMRC information;
attempting to match the decoded OMRC information to the OMRC information that is stored in the data structure with the association to the merchant identifier;
selectively validating the decoded OMRC information based on whether a match is identified;
responsive to when the decoded OMRC information is validated, sending to the user terminal an OMRC validation message containing an indication that the decoded OMRC information is valid, the transaction amount, and the merchant identifier;
receiving a transaction authorization message from the user terminal containing an indication that the transaction is authorized; and
responsive to when the decoded OMRC information is validated and receipt of the transaction authorization message containing the indication that the transaction is authorized, initiating transfer of funds from an issuer server associated with a user's account to an acquirer server associated with a merchant's account.

7. The transaction authorization server of claim 6, wherein:
the OMRC request message is received from the merchant terminal through a secure authorization network comprising a plurality of network nodes;
the OMRC response message is sent to the merchant terminal through the secure authorization network;
the OMRC verification message is received from the user terminal through a radio access network node that is outside of the plurality of network nodes of the secure authorization network; and
the OMRC validation message is sent to the user terminal through the radio access network node that is outside of the plurality of network nodes of the secure authorization network.

8. The transaction authorization server of claim 6, wherein:
the OMRC verification message contains the decoded OMRC information and a geographical location of the mobile terminal; and
the decoded OMRC information is selectively validated based on whether a match is identified and whether the location of the mobile terminal corresponds to a geographical location of the merchant terminal.

9. The transaction authorization server of claim 1, wherein the operations further comprise:
receiving from a user terminal an OMRC verification message containing decoded OMRC information that was scanned by the user terminal;
attempting to match the decoded OMRC information to the OMRC information that is stored in the data structure with the association to the merchant identifier;
selectively validating the decoded OMRC information based on whether a match is identified; and
responsive to when the decoded OMRC information is not validated, sending to the user terminal an OMRC validation message containing an indication that the decoded OMRC information is not valid and not containing either of the transaction amount and the merchant identifier.

10. The transaction authorization server of claim 1, wherein:
the OMRC request message is received from an acquirer server responsive to a message from the merchant terminal; and
the OMRC response message is sent to the acquirer server for communication of content thereof to the merchant terminal.

11. A merchant terminal comprising:
a network interface configured to communicate through data networks with a transaction authorization server;
a display device;
a processor coupled to the network interface and the display device; and
a memory coupled to the processor, the memory comprising a non-transitory computer-readable storage medium storing computer-readable program code therein that, when executed by the processor, causes the processor to perform operations comprising:
generating a transaction reference number for a transaction with a user;
obtaining a transaction time based on a time of day of the transaction;
obtaining a transaction amount;
obtaining a merchant identifier associated with the merchant terminal;
sending to the transaction authorization server an optical machine-readable code (OMRC) request message comprising the transaction reference number, the transaction time, the transaction amount, and the merchant identifier;
receiving from the transaction authorization server an OMRC response message containing OMRC information; and
displaying on the display device an OMRC based on the OMRC information.

12. The merchant terminal of claim 11, wherein the operation for displaying on the display device the OMRC based on the OMRC information, comprises:
generating a quick response (QR) code that encodes the transaction reference number and the transaction time; and
displaying the QR code on the display device.

13. The merchant terminal of claim 12, wherein the operation for generating a quick response (QR) code, further comprises:
generating the QR code to encode the transaction amount, the transaction reference number, and the transaction time.

14. The merchant terminal of claim 12,
wherein the operations further comprise obtaining a geographical location of the merchant terminal; and
wherein the operation for generating a quick response (QR) code, further comprises generating the QR code to encode the geographical location, the transaction reference number, and the transaction time.

15. The merchant terminal of claim 11,
wherein the operations further comprise obtaining a geographical location of the merchant terminal; and
wherein the OMRC request message sent to the transaction authorization server comprises, the geographical location of the merchant terminal, the transaction reference number, the transaction time, the transaction amount, and the merchant identifier.

16. A user terminal comprising:
a wireless transceiver configured to communicate through a wireless air interface with a radio access network;
an optical machine-readable code (OMRC) scanner device;
a display device;
a processor coupled to the wireless transceiver, the OMRC scanner device, and the display device; and
a memory coupled to the processor, the memory comprising a non-transitory computer-readable storage medium storing computer-readable program code therein that, when executed by the processor, causes the processor to perform operations comprising:
operating the OMRC scanner device to scan an OMRC displayed by a merchant terminal;
decoding the OMRC to obtain decoded OMRC information;
transmitting to a transaction authorization server an OMRC verification message containing the decoded OMRC information and a user terminal identifier;
receiving an OMRC validation message;
when the OMRC validation message that is received contains an indication that the decoded OMRC information is valid and further contains a transaction amount and a merchant identifier, performing operations:
displaying, on the display device, the transaction amount, the merchant identifier, and a query for a user to authorize the transaction; and
responsive to receiving through a user input interface a user response authorizing the transaction, transmitting a transaction authorization message toward the transaction authorization server containing an indication that the transaction is authorized.

17. The user terminal of claim 16, wherein the operation to transmit the OMRC verification message comprises:
obtaining a geographic location of the user terminal; and
embedding the location of the user terminal, the decoded OMRC information, and the user terminal identifier in the OMRC verification message for transmission.

18. The user terminal of claim 16, wherein the operations further comprise:
when the OMRC validation message that is received contains an indication that the decoded OMRC information is invalid, displaying on the display device a notification indicating that the OMRC displayed by the merchant terminal is invalid.

19. The user terminal of claim 16, wherein the OMRC comprises a quick response (QR) code that encodes the OMRC information.
